(19) United States
(12) Patent Application Publication
(10) Pub. No.: US 2006/0028818 A1
(43) Pub. Date: Feb. 9, 2006

(54) Automatic swiveling lamp for a vehicle

(75) Inventor: Yih-Cherng Wu, Kuohsing Hsiang (TW)

Correspondence Address: NIKOLAI & MERSEREAU, P.A., 900 SECOND AVENUE SOUTH, SUITE 820, MINNEAPOLIS, MN, 55402, US

(73) Assignees: Chien-Hung Lee, Taichung Hsien (TW); Yih-Cherng Wu, Nantou Hsien (TW)

(21) Appl. No.: 10/912,889

(22) Filed: Aug. 5, 2004

(51) Int. Cl. F21V 33/00

(52) U.S. Cl. 362/253

(57) ABSTRACT

An automatic swiveling lamp for a vehicle has a fixed base, a rotating base, a light, a lateral driving device, a longitudinal device and a main controller. The rotating base is rotatably attached to the fixed base in a lateral direction. The light is rotatably attached to the rotating base in a longitudinal direction vertical to the lateral direction. The lateral driving device is connected to the rotating base to rotate the rotating base relative to the fixed base. The longitudinal driving device is connected to the light to rotate the light relative to the rotating base. The main controller electrically connected to the lateral driving device and the longitudinal driving device to actuate the lateral driving device and the longitudinal driving device to operate. Accordingly, the lamp can be automatically adjusted base on the deflection angle of a front wheel or a steering wheel of the vehicle.

### BACKGROUND OF THE INVENTION

1. Field of the Invention

The present invention relates to a lamp, and more particularly to an automatic swiveling lamp for a vehicle and that can automatically rotate based on a deflection angle of front wheels or a steering wheel of the vehicle.

2. Description of Related Art

To improve safety of driving in a dark environment, auxiliary lamps, such as fog lamps are mounted on a front of a vehicle to keep accidents from occurring. However, a conventional auxiliary lamp is securely attached in a fixed direction to a vehicle and cannot be adjusted after the lamp has been secured. Therefore, the projecting direction of the light emitting from a conventional auxiliary lamp is fixed and is not adjustable, such that the use of the conventional auxiliary lamp is not versatile.

To overcome the shortcomings, the present invention tends to provide an automatic swiveling lamp to mitigate or obviate the aforementioned problems.

### SUMMARY OF THE INVENTION

The main objective of the invention is to provide an automatic swiveling lamp that can be automatically adjusted base one the deflection angle of a front wheel or a steering wheel of a vehicle. The lamp has a fixed base, a rotating base, a light, a lateral driving device, a longitudinal device and a main controller. The rotating base is rotatably attached to the fixed base in a lateral direction. The light is rotatably attached to the rotating base in a longitudinal direction vertical to the lateral direction. The lateral driving device is connected to the rotating base to rotate the rotating base relative to the fixed base. The longitudinal driving device is connected to the light to rotate the light relative to the rotating base. The main controller electrically connected to the lateral driving device and the longitudinal driving device to actuate the lateral driving device and the longitudinal driving device to operate.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an automatic swiveling lamp in accordance with the present invention;

FIG. 2 is an operational perspective view of the automatic swiveling lamp in FIG. 1 showing that a rotating base with a light is rotated in a lateral direction relative to a fixed base;

FIG. 3 is an operational perspective view of the automatic swiveling lamp in FIG. 1 showing that the light is rotated in a longitudinal direction relative to the rotating base; and

FIG. 4 is a block diagram of a control system of the automatic swiveling lamp in FIG. 1.

### DETAILED DESCRIPTION OF PREFERRED EMBODIMENT

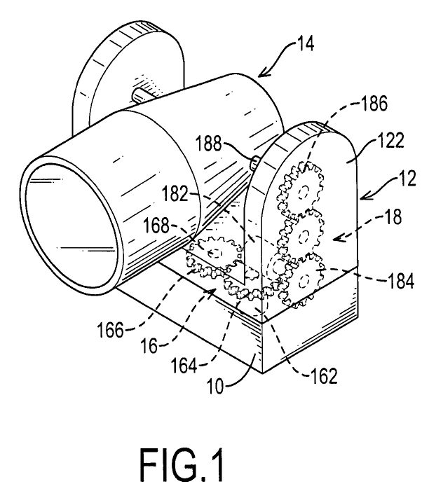

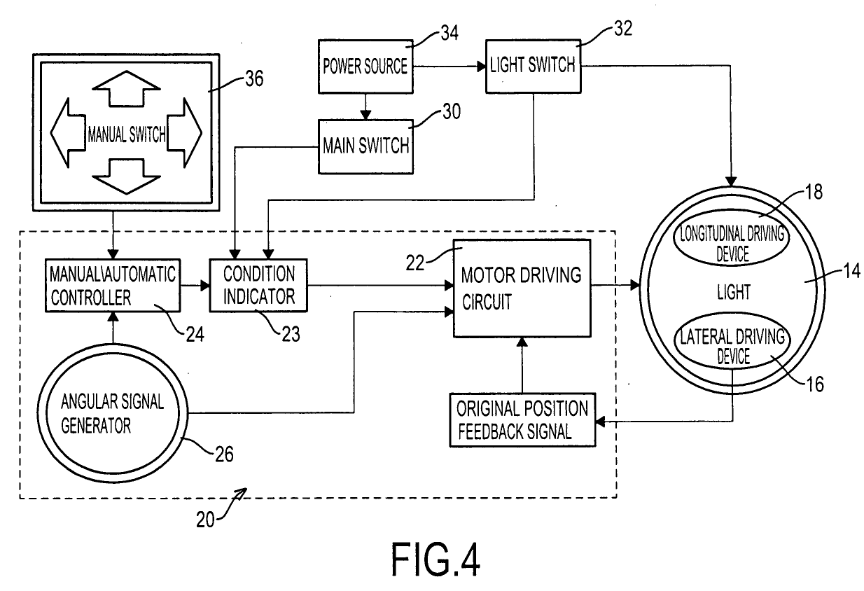

With reference to FIGS. 1 and 4, an automatic swiveling lamp for a vehicle in accordance with the present invention comprises a fixed base (10), a rotating base (12), a light (14), a lateral driving device (16), a longitudinal driving device (18) and a main controller (20). The fixed base (10) is securely attached to a front of the vehicle, such as a bumper. The rotating base (12) is rotatably attached to the fixed base (10) in a lateral direction. In a preferred embodiment, the rotating base (12) is U-shaped to form two arms (122).

The light (14) is rotatably attached to the rotating base (12) in a longitudinal direction vertical to the lateral direction. With a U-shaped rotating base (12), the light (14) is rotatably mounted between the arms (122) of the rotating base (12).

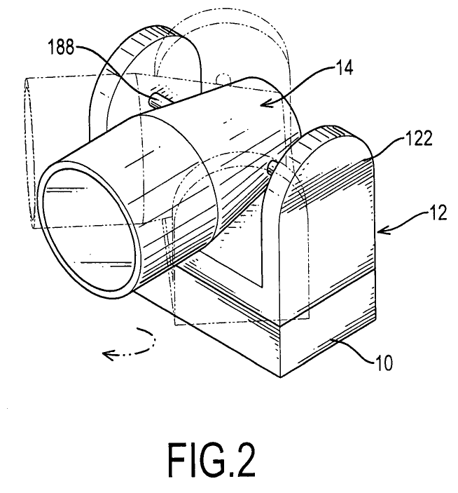

The lateral driving device (16) is connected to the rotating base (12) to rotate the rotating base (12) relative to the fixed base (10). In an optional embodiment, the lateral driving device (16) is mounted inside the fixed base (10) and comprises a first motor (162), a first pivot (168) and a lateral transmission device. The first motor (162) is mounted inside the fixed base (10) and has a first rotating shaft. The first pivot (168) is connected to the rotating base (12) and is driven by the first motor (162) with the lateral transmission device. The lateral transmission device comprises a lateral driving gear (164) and a lateral driven gear (166). The lateral driving gear (164) is attached to the first rotating shaft, and the lateral driven gear (166) engages with the lateral driving gear (164) and is secured with the first pivot (168). When the first motor (162) is switched on, with further reference to FIG. 2, the first pivot (168) with the rotating base (12) is driven to rotate relative to the fixed base (10) with the transmission of the lateral driving gear (164) and the lateral driven gear (166).

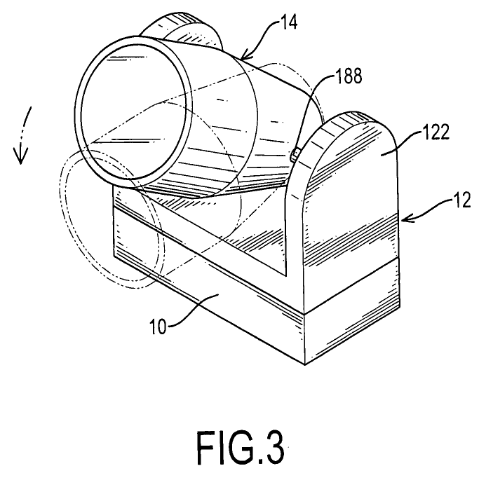

The longitudinal driving device (18) is connected to the light (14) to rotate the light (14) relative to the rotating base (12). The longitudinal driving device (18) is mounted inside the rotating base (12) and comprises a second motor (182), a second pivot (188) and a longitudinal transmission device. The second motor (182) is mounted inside the rotating base (12) and has a second rotating shaft. The second pivot (188) is connected to the light (14) and is driven by the second motor (182) with the longitudinal transmission device. In an optional embodiment, the longitudinal transmission device is mounted inside one of the arms (122) of the rotating base (12) and comprises a longitudinal driving gear (184) and at least one longitudinal driven gear (186). The longitudinal driving gear (184) is attached to the second rotating shaft. The at least one longitudinal driven gear (186) engages with the longitudinal driving gear (184) in series, and the second pivot (188) is attached to one of the at least one longitudinal driven gear (186). When the second motor (182) is switched on, with further reference to FIG. 3, the light (14) will be driven to rotate relative to the rotating base (12) with the transmission of the longitudinal transmission device (18).

With reference to FIGS. 1 and 4, the main controller (20) is electrically connected to the lateral driving device (16) and the longitudinal driving device (18) to actuate the lateral driving device (16) and the longitudinal driving device (18) to operate. The main controller (20) comprises a motor driving circuit (22), a condition indicator (23), a manual/automatic controller (24) and an angular signal generator (26).

The motor driving circuit (22) is electrically connected to the motors (162,182) of the lateral driving device (16) and the longitudinal driving device (18). The condition indicator (23) is electrically connected to the motor driving circuit (22). A main switch (30) electrically connected to an electrical power source (34) is connected to the condition indicator (23). In addition, a light switch (32) is respectively connected to the condition indicator (23), the light (14) and the electrical power source (34). In an optional embodiment, the power source (34) can be a storage battery in the vehicle or a dry battery.

The manual/automatic controller (24) is electrically connected to the condition indicator (23), such that modes of the controller (24) can be distinguished by the condition indicator (23). A manual switch (36) is electrically connected to the manual/automatic controller (24).

The angular signal generator (26) is electrically connected to the motor driving circuit (22) and the manual/automatic switch (36). The angular signal generator (26) is mounted on the vehicle at a position corresponding to a front wheel or a transmission mechanism of a steering wheel to detect the deflection angle of the front wheel or the rotating angle of the steering wheel.

When the light switch (32) is actuated, the light (14) will be lighted up. When the main switch (30) is actuated, the main controller (20) is powered on and a signal is transformed to the motor driving circuit (22) from the condition indicator (23). The motor driving circuit (22) will generate a control signal based on the angular signal detected by the angular signal generator (26). If the manual/automatic controller (24) is switched to an automatic mode, the motor driving circuit (22) will send the control signal to the first motor (162) of the lateral driving device (16) to make the rotating base (12) with the light (14) rotate at a desired angle. Consequently, the light (14) will automatically rotate at a lateral angle according to the deflection angle of a corresponding front wheel or the rotating angle of the steering wheel, such that the driver has clear vision in a direction to which the vehicle is turned.

If the manual/automatic controller (24) is switched to a manual mode, the lateral angle and the longitudinal angle of the light (14) can be manually adjusted with the manual switch (36) through the motor driving circuit (22). Accordingly, the emitting direction and angle of the light (14) can be fixed according to a specific need of the user.

In an operational embodiment, the motor driving circuit (22) can keep the rotating base (12) with the light (14) stationary and from rotation when the front wheel or the steering deflects within a desired small angle range. After the front wheel or the steering wheel deflects or rotates over the desired angle range, the motor driving circuit (22) sends a signal to drive the light (14) to rotate. In addition, when the vehicle is powered off, an original position feedback signal will be sent to the motor driving circuit (22) to make the rotating base (12) with the light (14) to rotate to an original position.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An automatic swiveling lamp comprising:
a fixed base;
a rotating base rotatably attached to the fixed base in a lateral direction;
a light rotatably attached to the rotating base in a longitudinal direction vertical to the lateral direction;
a lateral driving device connected to the rotating base to rotate the rotating base relative to the fixed base;
a longitudinal driving device connected to the light to rotate the light relative to the rotating base; and
a main controller electrically connected to the lateral driving device and the longitudinal driving device to actuate the lateral driving device and the longitudinal driving device to operate.

2. The lamp as claimed in claim 1, wherein the rotating base is U-shaped to form two arms; and
the light is rotatably mounted between the arms of the rotating base.

3. The lamp as claimed in claim 2, wherein the lateral driving device is mounted inside the fixed base and comprises:
a first motor with a first rotating shaft mounted inside the base; and
a first pivot connected to the rotating base and driven by the first motor with a lateral transmission device.

4. The lamp as claimed in claim 3, wherein the lateral transmission device comprises
a lateral driving gear attached to the first rotating shaft; and
a lateral driven gear engaging with the lateral driving gear.

5. The lamp as claimed in claim 3, wherein the longitudinal driving device is mounted inside the rotating base and comprises:
a second motor mounted inside the rotating base and having a second rotating shaft; and
a second pivot connected to the light and driven by the second motor with a longitudinal transmission device.

6. The lamp as claimed in claim 5, wherein the longitudinal transmission device comprises:
a longitudinal driving gear attached to the second rotating shaft; and
at least one longitudinal driven gear engaging with the longitudinal driving gear in series, wherein the second pivot is attached to one of the at least one longitudinal driven gear.

7. The lamp as claimed in claim 5, wherein the main controller comprises:
a motor driving circuit electrically connected to the respective motors of the lateral driving device and the longitudinal driving device;
a condition indicator electrically connected to the motor driving circuit;
a manual/automatic controller electrically connected to the condition indicator; and
an angular signal generator electrically connected to the motor driving circuit and the manual/automatic controller.

8. The lamp as claimed in claim 1, wherein the longitudinal driving device is mounted inside the rotating base and comprises:
a second motor mounted inside the rotating base and having a second rotating shaft; and
a second pivot connected to the light and driven by the second motor with a longitudinal transmission device.

9. The lamp as claimed in claim 8, wherein the longitudinal transmission device comprises:
a longitudinal driving gear attached to the second rotating shaft; and
at least one longitudinal driven gear engaging with the longitudinal driving gear in series, wherein the second pivot is attached to one of the at least one longitudinal driven gear.
